(19) United States
(12) Patent Application Publication
(10) Pub. No.: US 2007/0057403 A1
(43) Pub. Date: Mar. 15, 2007

(54) Methods involving a molded impression of a natural nail surface in the creation of an artificial nail

(76) Inventors: Scott L Nielson, Layton, UT (US); Craig P Gifford, West Jordan, UT (US)

Correspondence Address: SCOTT NIELSON, 1076 WALBURK AVE, LAYTON, UT, 84040, US

(21) Appl. No.: 11/162,439

(22) Filed: Sep. 9, 2005

(51) Int. Cl. B29C 33/40

(52) U.S. Cl. 264/222

(57) ABSTRACT

Methods are described delineating a means of taking an impression molding of a natural nail surface, converting that impression into a three dimensional data structure, separating any surrounding tissue from the natural nail surface, permitting easy manipulation in the creation of a desired three dimensional artificial fingernail object. With the desired digital three dimensional artificial nail object, a tool path is created that permits a desired customized artificial nail to be physically produced from a chosen material consisting of plastics, metals or ceramics, by using a CNC machine. The invention has many applications but the preferred embodiments show its application on fingernails and toenails.

### THE FIELD OF THE INVENTION

The present invention relates to custom fit artificial nails and, more specifically, to methods of creating a custom fit artificial nail from a mold impression of a natural nail surface.

### BACKGROUND AND RELATED ART

Artificial nails (fingernails and toenails) typically comprise thin, elongated, plastic structures having a configuration substantially similar to a real fingernail. Through use of an adhesive, the artificial fingernails can be selectively secured to existing fingernails. One of the benefits of artificial nails is that they enable a user to selectively have uniform nails of a desired thickness, length, and configuration without having to wait for the real nails to grow. This is especially useful to those who have weak nails that easily crack or break.

One method of applying artificial nails used in nail salons involves a time-consuming and laborious process of applying an acrylic to each natural nail surface. After the application of the acrylic the artificial nail is shaped by a nail technician. The above process requires one skilled in application of acrylic and the results are generally improved with experience. Another method involves the application of prefabricated nails. These prefabricated nails are painstakingly shaped to fit the cuticle end of the natural nail surface. The problem with this approach is that each nail surface has its own unique curvature and arch that a prefabricated artificial nail simply cannot anticipate. Additionally, the prefabricated nails are made from materials that are not reusable thus requiring the process of shaping to be repeated each time a desire for artificial nails is presented.

The solution to the current problems in the field of artificial nails is to create a customized artificial nail product composed of material that allows the customized product to be reused. This solution is presented by U.S. Pat. No. 5,968,302 and U.S. Pat. No. 6,196,234. These patents are directed to precision fit nails and methods for manufacturing precision fit nails. The precision fit nails described in these patents address many of the problems described above because they are made using models of real nails to cast acetone resistant thermoplastic artificial nails with a bottom surface that closely matches the top surface of the corresponding real nails. However, the processes of measuring for and manufacturing precision fit nails in accordance with U.S. Pat. No. 5,968,302 and U.S. Pat. No. 6,196,234 are somewhat complex and generally require a substantial amount of labor.

In U.S. Pat. No. 5,552,992 a method is presented for using a laser scanner in conjunction with a CNC in creating physical articles through rapid prototyping. This patent is directed towards rapid prototyping tooling objects; rather then actually mass manufacturing a customized object. The problem in this prior art is not a subtle problem when considering the need for manufacturing methods that can quickly and accurately permit mass customization of a manufactured article. An additional problem in this prior art is the time consuming and laborious task of actually creating a three-dimensional representation of the scanned item.

U.S. Pat. No. 5,768,134 describes a method for making a medical model of a part of the human body by rapid prototyping. The prior art referred to here assumes that the use of the invention is limited to simulated medical procedures; rather then to the mass manufacturing of customized articles into the marketplace. The costs of creating the digital information and eventually the prototype model contemplated by this patent are also prohibitive.

In U.S. Pat. No. 5,911,126 a method of digitizing body parts is presented for automated production of artificial limbs. The focus of this patent is in presenting a passive, more hygienic body part scanning method for use in digitizing a body part. This prior art requires covering the body part with a high contrast envelope, which is used to aid the scanning method. The problem in this prior art relates to the lack of object definition in regards to a fingernail surface area. While this prior art may be well-suited for scanning legs, arms or entire bodies, it does not permit the accuracy required for scanning natural nail surfaces.

U.S. Pat. No. 6,177,034 provides methods for creating customized three dimensional prosthetic surfaces from mold impressions. The approach in this patent requires that a positive mold impression is created after the original mold impression has been created. This positive mold impression is then digitized and customized prosthetic details are then added to the positive 3D scan. The process of this patent is needlessly time consuming, wasteful and complicated. The application of this patent is more applicable to appendages like fingers and toes at best, so it is improbable that reliable and accurate results of molding natural nail surface could be achieved with the approach described in this prior art.

U.S. Pat. No. 6,463,351 is directed towards providing artificial limbs through the use of molds and scanning those molds to create a customized medical prosthetic device. A serious drawback in this patent is the requirement for physicians or experts in the field of prosthetics to be involved in creating the mold. Just like other prior art, this patent involves a laborious process demanding sophisticated skills and experience to successfully create the desired mold.

The prior art presents many varied applications of technology to molding, three-dimensional imaging and manufacturing. The universal problem in the prior art is its failure, in general, to allow mass manufacturing of customized articles, created from a three dimensional scan of a mold. This failure is demonstrated by the lack of speed, accuracy and reliability in the methods utilized to achieve the result. Further, the prior art generally requires specialized skills and is very time consuming.

### BRIEF DESCRIPTION OF THE DRAWINGS

In order to describe the manner in which the recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 is a flowchart demonstrating the method and process of taking an impression using the nail surface mold enclosure.

FIG. 2 is an illustration of the method and process of taking an impression of a natural nail surface by using the nail surface mold enclosure.

FIG. 3 is a flowchart describing the method and process of scanning the impression result contained in the nail surface mold enclosure.

FIG. 4 is an illustration of the method and process involved in positioning the nail surface mold enclosure for scanning said mold, then recording and storing the results of the scan.

FIG. 5 is a flowchart and illustration showing the method and process of removing the natural nail surface from any surrounding tissue and then orienting the natural nail surface.

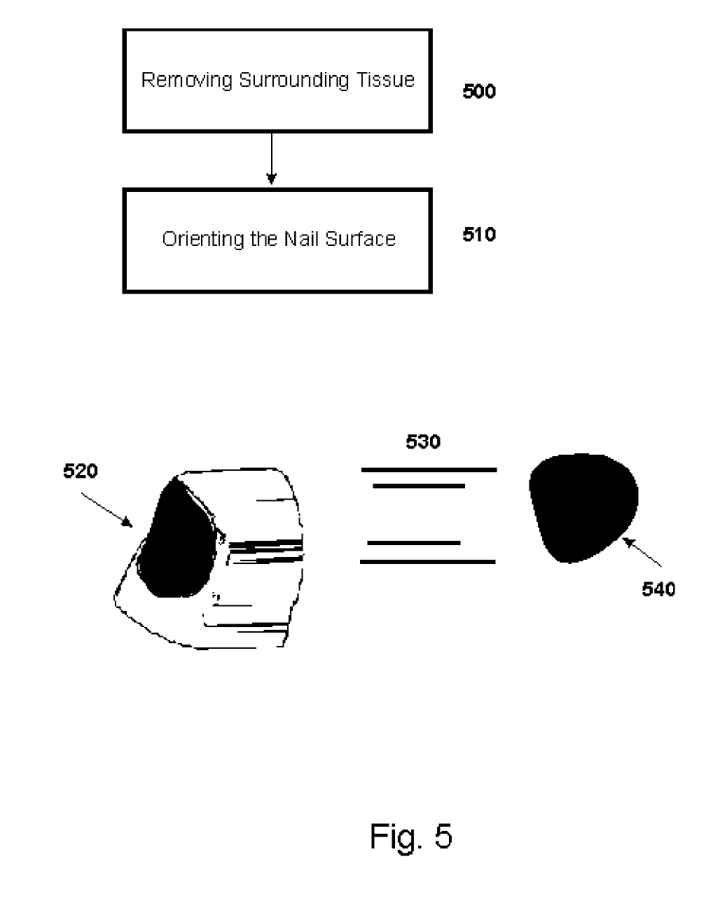

FIG. 6 is a flowchart demonstrating the creation of a desired three dimensional artificial nail object.

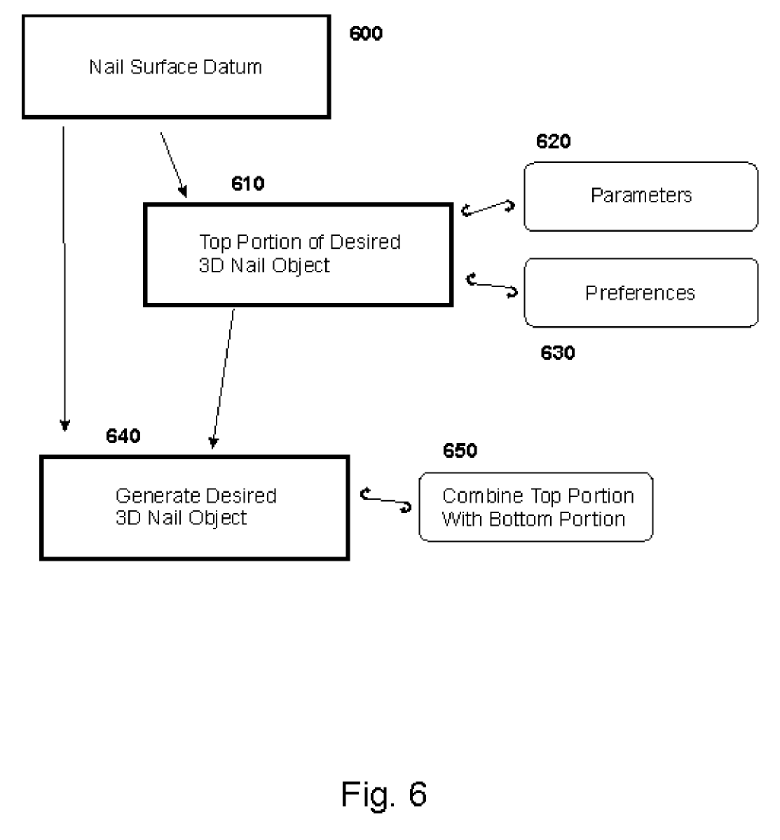

FIG. 7 is an illustration of the method and process involved in creating a desired three dimensional artificial nail object from a digitized nail surface.

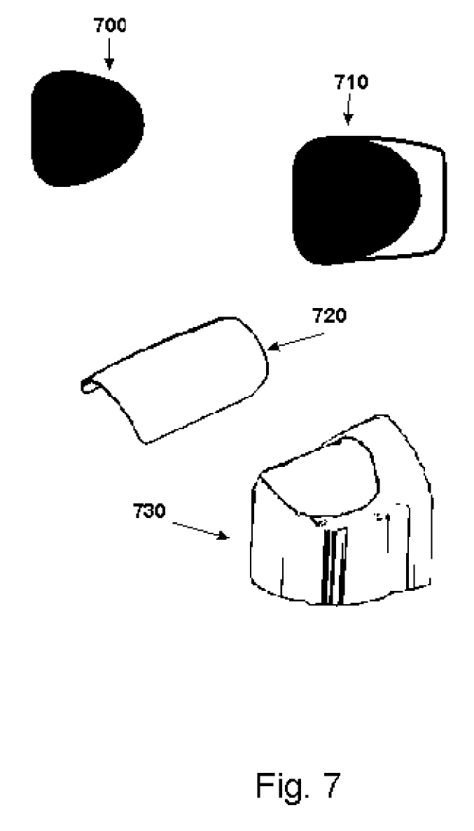

FIG. 8 is a flowchart describing the method and process of producing a physical artificial nail from a chosen material.

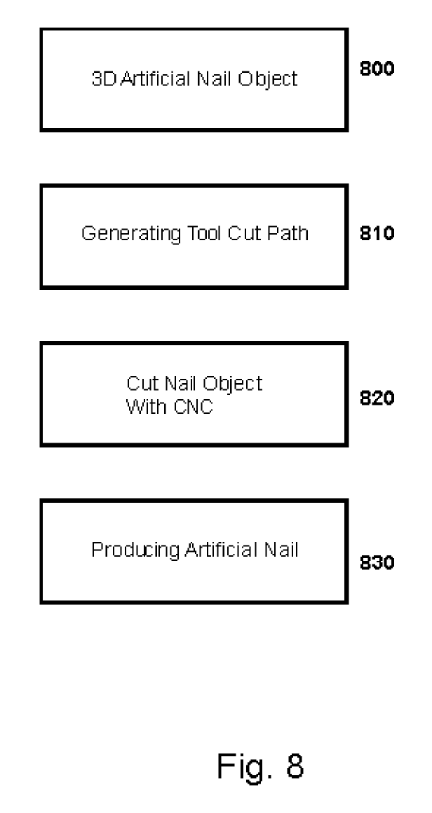

FIG. 9 is an illustration of the steps involved in producing an actual artificial nail object that is customized to the impression previously taken of a natural nail surface.

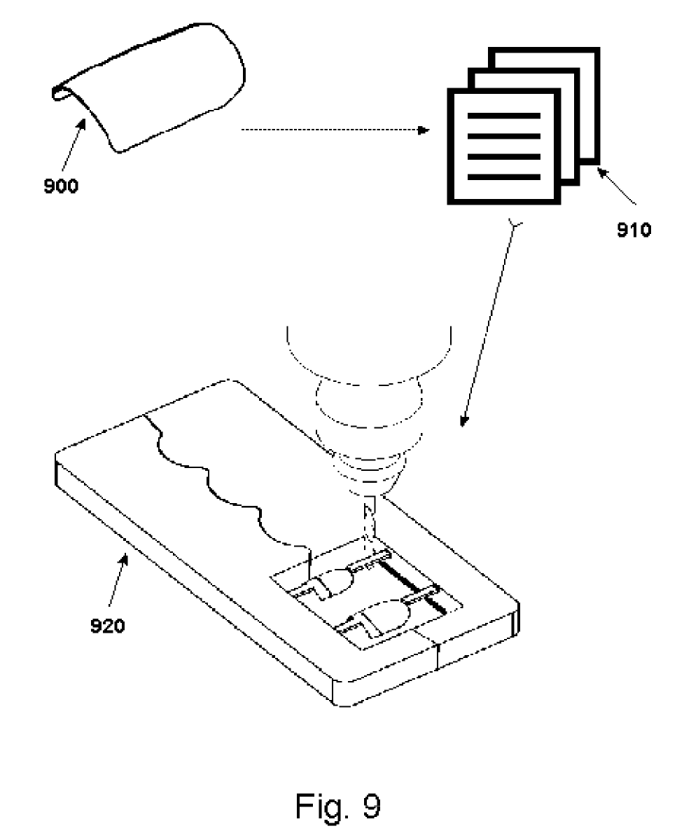

### DETAILED DESCRIPTION OF THE PREFERRED EMBODIMENTS

The present invention is directed to methods involved in simplifying the process of taking impression molds of a natural nail surface and then creating a desired artificial fingernail based upon the natural nail surface impression and any individualized consumer preferences or parameters. Once the impression molds have been completed and returned to the manufacturing facility, the impression molds can then be imaged, creating a three dimensional surface permitting the creation of a customized reusable artificial nail product for the consumer. In the description that follows, tasks may be described in a sequence that has been selected to facilitate an understanding of the disclosed embodiments of the invention. It should be clear, however, that in practicing the invention, many tasks may be performed in an arbitrary order, and therefore any particular order implied by the description usually represents one of many possibilities.

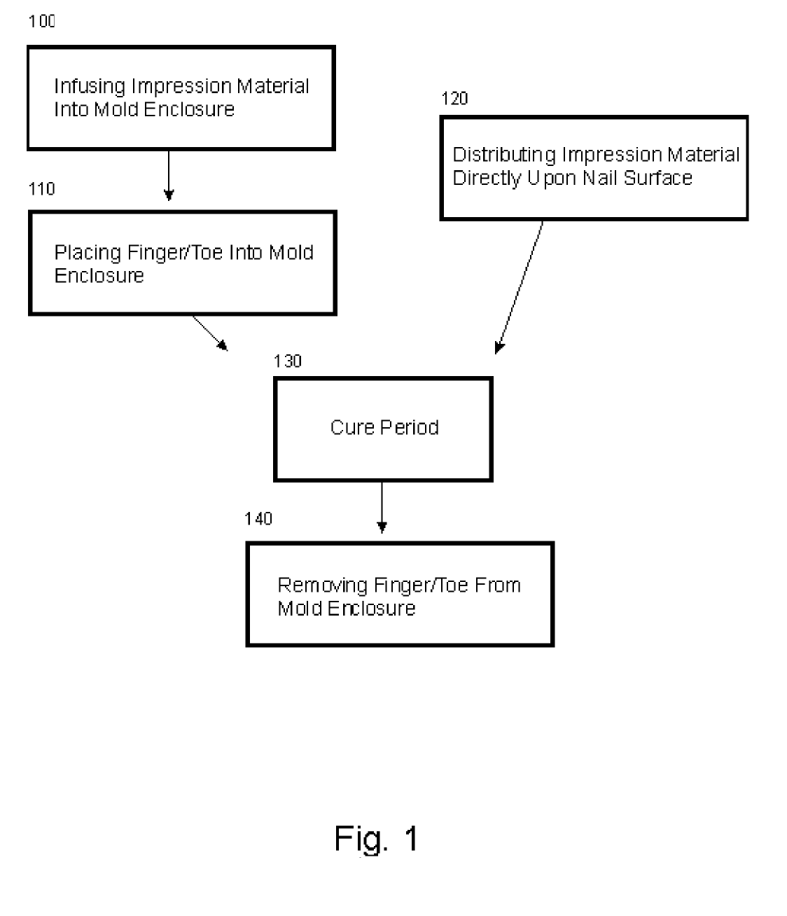

The first step in the method of creating a customizable artificial nail product starts with the consumer taking an impression of their natural nail. The flowchart of FIG. 1 outlines the basic steps required to take an impression mold of the natural nail surface. The consumer starts by infusing impression material into the mold enclosures 100. After enough impression material has been placed inside the mold enclosure the consumer places their finger or toe into the enclosure 110. As an alternative, the consumer can simply distribute impression material directly upon their nail surface and any surrounding tissue 120. After waiting for the impression material to cure or harden 130, the consumer can then remove their finger or toe from the mold enclosure 140, resulting in an impression of their natural nail surface.

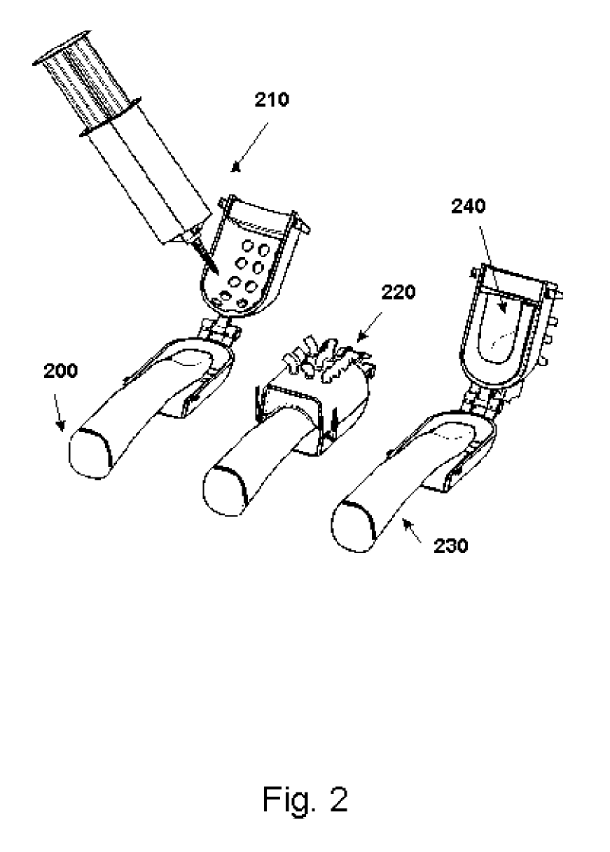

The simplified method of achieving a successful nail surface impression is further illustrated by FIG. 2. The finger or toe rests comfortably in the nail surface mold enclosure 200, which has been designed specifically to fit the over the fingers or toes, and is available in various sizes. The top of the nail surface mold enclosure is designed with pressure release holes and will either snap over or onto the bottom portion of the nail surface mold enclosure. The consumer then distributes impression material into the top portion 210 of the nail surface mold enclosure. The top surface is marked so that the consumer knows how much impression material to infuse before fastening the two pieces together.

After properly preparing the top surface and with the finger or toe resting comfortably in the bottom portion of the nail surface mold enclosure, the mold enclosure is then snapped together or the top portion is fastened or attached to the bottom portion during the cure period 220. The cure period allows the impression material to harden or set up and with the mold enclosure surrounding the finger or toe it insures that accurate and reliable results will be achieved as the nail surface will remain stationary and in contact with the impression material. The top portion is strategically lined with holes to allow impression material to escape through the holes, this prevents voids and gaps from inverted pressure by the impression material.

Once the cure period 220 has expired, the consumer will open the mold enclosure and gently remove their finger 230 from the mold enclosure. The result will be an impression of the top surface of their finger, surrounding tissue and the nail surface 240. The natural nail surface is what is desired by this method and process. The consumer then gathers the mold enclosures representing the nail surfaces that are to have artificial nail products manufactured and sends those enclosures for further processing.

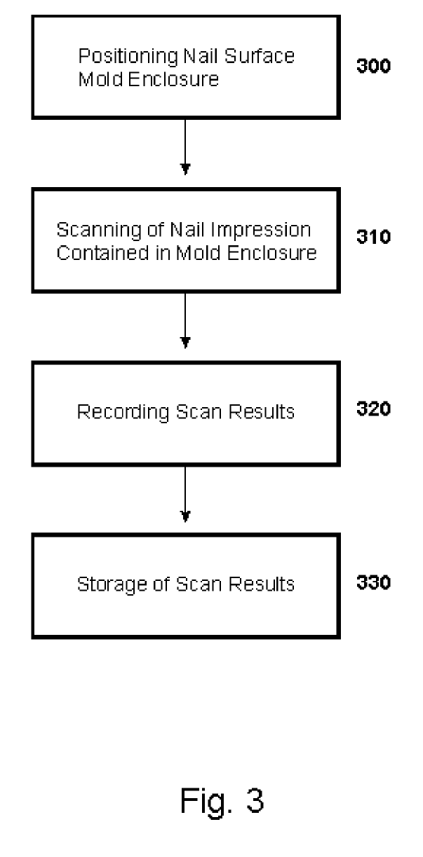

The flowchart of FIG. 3 demonstrates the next step in the method of using the natural nail surface as derived from the previously achieve impression mold method and process. By positioning the mold enclosure 300 and scanning the nail impression contained within that mold enclosure 310, data results reflecting the nail surface area are recorded 320 and stored 330 for future manipulation.

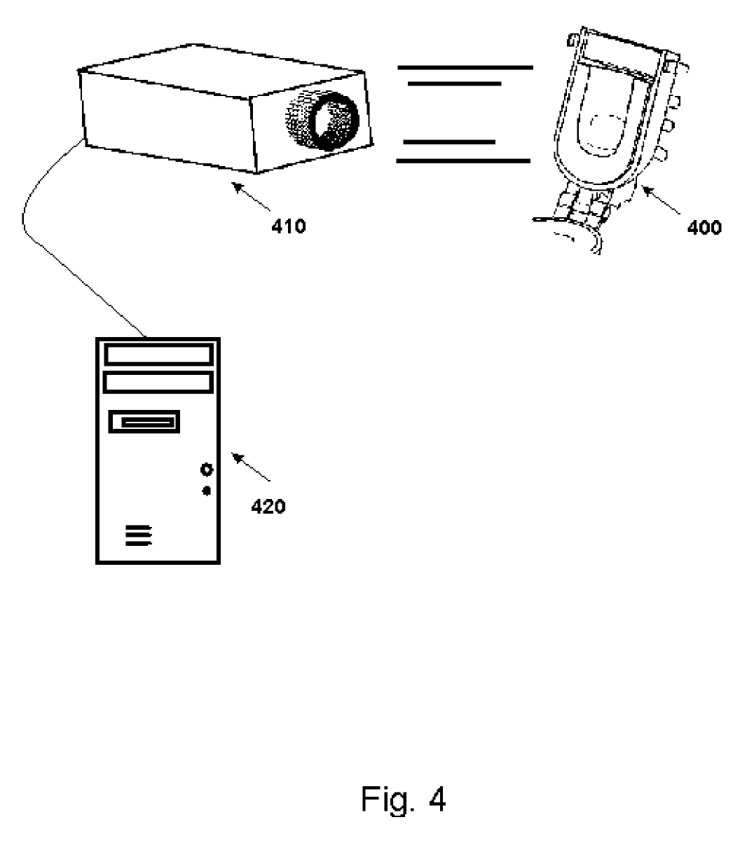

FIG. 4 illustrates the steps of using the mold enclosures at the manufacturing facility. The mold enclosures are positioned 400 facing a scanning device 410. The positioning allows the consumer preferences and parameters to be used in the creation of the eventual artificial nail product to be tracked along with the impression molds of the natural nails surfaces. The scan results and preferences are then recorded and stored in a storage device 420; typically this will be a computer system, but this can be any type of storage device that maintains the results of the scan and the customer preferences. The scanning of the nail surface mold enclosure unique data is achieved representative of the curvature, arc, length, breadth and width of the natural nail surface.

The data from the scanning of the impressions of the natural nail surface may be reflected in color, numerical or spatial representations, including an X, Y, Z coordinate system.

The next step involves removal of any surrounding tissue around the natural nail surface area 500. The three dimensional nail surface object 520 will represent a three dimensional finger or toe and will contain information that is not required for the successful creation of a desired three dimensional artificial nail object. The surrounding tissue is removed by using edge detection and color recognition techniques 530. Once the natural nail surface has been removed from the surrounding tissue, the nail surface is oriented 510 along the X, Y and Z axis in anticipation of the next step involved in actually generating a new three dimensional nail object using the natural nail surface as a reference. The result is a properly oriented nail surface 540 without any surround data that is not required for the successful creation of the desired three dimensional artificial nail object.

The oriented nail surface 700 is then referenced 600 and is used to begin the creation of the top surface of the eventual three dimensional object 610. The top surface of the desired three dimensional object considers any nail creation parameters 620 and any consumer preferences 630 during the process of generating the top surface. Particular consideration is applied in the calculations regarding the overall thickness of the desired three dimensional nail object. Finally the bottom nail surface 600 is combined 650 with the top surface 610 to create a desired three dimensional artificial nail object 640.

The final desired three dimensional artificial nail object 720 will reflect desired arcs, curves, the customized fit, any special parameters and the consumer preferences relating to length, smile line placement, type, and style 710. the final desired three dimensional artificial nail object 720 will also fit comfortably over the three dimensional rendering of the original nail surface, possibly inclusive of surrounding tissue and finger 730. This allows for a computerized three dimensional fit to be established before the physical nail is produced by the milling machine.

Upon completion of the generation of the desired three dimensional artificial nail object 800, a tool path can be calculated 810. Once the tool path has been created, the artificial nail product 830 can be physically cut from a chosen material by using a CNC machine 820.

The desired three dimensional artificial nail object 900 may be cut with other artificial nail objects or cut individually. The calculation of the tool path 910 is accomplished by considering the dimensions of the material that the artificial nail object is to be removed from, where the artificial nail object 900 intersects the chosen material a reference is made regarding the X, Y and Z position of the artificial nail object and the material dimensions. This permits a calculation to be accomplished telling the CNC machine 920 where to move along the tool path. Tabs may be used 920 to hold the produced artificial nail objects in place until the CNC cutting process has completed.

The chosen material may be any type of raw material that is desired for an artificial nail product. Specifically plastic, metal or ceramic all make excellent choices for the material to use in manufacturing a customized artificial nail product.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of producing a cast of a natural nail surface comprising the steps of:
infusing impression molding material into a mold enclosure designed to fit around the nail surface; placing the nail surface into the enclosure with the impression molding material; alternatively the impression molding material may be distributed directly onto the nail surface and possibly the surrounding tissue; waiting for the impression molding material to cure; removing the nail surface molded object from the impression molding material resulting in a negative mold of the natural nail surface and any surrounding tissue.

2. The method of claim 1, wherein the impression molding material may be any molding material which maintains dimensional stability after it has been removed from the natural nail surface object being molded.

3. The molding material of claim 2, wherein the molding material may include sodium alginates, thermoplastic molding resins, silicones, reversible hydro colloids, poly ethers, vinyl polysiloxane, clay, putty, wax and plaster.

4. The sodium alginate molding material of claim 3, wherein sodium alginate includes a compound that is mixed with water until a creamy consistency is achieved. The compound may be mixed with accelerators to speed up the cure time. Generally these compounds maintain their dimensional stability for a short period of time resulting in a need to immediately process the impression of the nail surface.

5. The thermoplastic molding resin molding material of claim 3, wherein the thermoplastic molding material includes materials that when heated will soften to form a pliable mixture, which can then be used to cast around the natural nail surface. When allowed to cool, the material re-hardens representing the new captured nail surface shape and will maintain dimensional stability for a long period of time.

6. The silicone molding material of claim 3, wherein the silicone materials use a putty that when mixed with drops of a catalyst, will harden over the new desired nail surface shape. This material has great dimensional stability and maintains elastomeric properties.

7. The vinyl polysiloxane molding material of claim 3, wherein the vinyl polysiloxane includes two pastes, which can be mixed by hand or extruded through an auto mixing tip, which when mixed combines the body with the catalyst resulting in a desired impression material that maintains dimensional stability and accurately reflects a nail surface impression when molded.

8. The method of claim 1, wherein infusing impression molding material requires that the molding material be placed into the mold enclosure, preferably into the top portion of the mold enclosure, where the bottom portion of the mold enclosure comfortably fits around a finger or toe and the top portion is designed to contain the nail surface impression mold after the portions have been pressed together for the duration of the cure time.

9. The method of claim 1, wherein the placement of the nail surface involves inserting the appropriate finger or toe containing the natural nail surface desired to be cast in the impression molding material into the bottom of the mold enclosure.

10. The method of claim 1, wherein the placement of the nail surface into the mold enclosure also involves closing the top portion of the mold enclosure over the bottom portion of the mold enclosure.

11. The alternative method of distributing the impression molding material directly onto the nail surface of claim 1, wherein a mold enclosure is not used. However, the molding material may be applied directly to the nail surface and any surrounding tissue in order to achieve the desired result of creating an impression of the natural nail surface.

12. The method of waiting for the impression molding material to cure of claim 1, wherein after the impression mold material has been cast in either the mold enclosure or directly on the desired nail surface, the material requires a short amount of time to cure or harden around the nail surface.

13. The method of claim 1, wherein removing the molded nail surface object from the enclosure or in the alternative from the impression molding material is performed after the impression molding material has cured and the result is an accurate and dimensionally stable impression mold of a desired natural nail surface.

14. A method of digitally reproducing the impression result of a nail surface mold comprising the steps of:
positioning the nail surface mold for scanning; scanning the physical impression of the nail surface mold to obtain data representative of the dimensional characteristics of the impression nail surface and any surrounding tissue; recording the dimensional data of the impression nail surface and any surrounding tissue in a format that is useful for reproduction of the impression nail surface.

15. The method of claim 14, wherein positioning the nail surface mold for scanning involves placing the nail surface mold appropriately in relation to the scanning device so as to maximize accuracy in the scan result.

16. The method of claim 14, wherein positioning the nail surface mold for scanning includes considerations for tracking multiple molds representative of a desire to place artificial nails upon all digits of hands or feet.

17. The method of claim 14, wherein positioning the nail surface mold for scanning may include removal of any extra impression mold flashing that obstructs the view of the scanning device.

18. The method of claim 14, wherein scanning the physical impression of the nail surface mold may be achieved by using any type of scanning device that can provide data representative of the dimensional characteristics of the nail surface mold being scanned.

19. The scanning device of claim 18, wherein said devices may be laser scanning devices, holography imaging devices, LIDAR imaging devices, touch probes, optical position trackers, magnetic position trackers, acoustic position trackers, optical fiber imaging devices, dense stereo matching, coordinate measurement machines, structured light imaging devices, and photogrammetry.

20. The method of claim 14, wherein the dimensional data may be represented by numerical, color or spatial data of the molded natural nail surface and any surrounding tissue.

21. The method of claim 20, wherein, numerical data includes any representation of the nail surface by numbers or scientific notation.

22. The method of claim 20, wherein, color data includes any representation of the nail surface by common computer color recognition methods including RGB (Red, Blue, Green) and/or CMYK (Cyan, Magenta, Yellow, Black) and/or gray scale.

23. The method of claim 20, wherein, spatial data includes any representation of the nail surface by amplitude, breadth, width, length or expanse; further comprising any geometrical coordinate representation similar to an XYZ coordinate system where the data may reflect points, vectors, or vertices to create any type of geometrical lines and/or shape(s).

24. The method of claim 14, wherein recording the dimensional data involves storing in a data storage system, the dimensional data provided by the scanning device of the molded natural nail surface and any surrounding tissue.

25. A method of manipulating three dimensional data of a nail surface derived from a nail surface mold comprising the steps of:
removing the surrounding tissue from the three dimensional nail surface data; orienting the three dimensional nail surface data, resulting in oriented three dimensional nail surface data without any surrounding tissue.

26. The method of claim 25, wherein removing surrounding tissue from the three dimensional nail surface data involves an analysis of the nail surface data to determine if any surrounding tissue has been included in the data.

27. The method of claim 26, wherein the analysis may be computer driven or a human modeler.

28. The method of claim 26, wherein the analysis may be accomplished by using color recognition or surface edge detection.

29. The method of claim 28, wherein color recognition involves isolating all of the color data values within a tolerance range within the nail surface data.

30. The method of claim 28, wherein surface edge detection includes the systematic approach of evaluating all of the nail surface data until the edge of the nail surface data is determined and then following and recording that edge around the nail surface data and all subsequent points of data until the original edge is recorded indicating completion of the edge detection process. The method used may evaluate multiple edge positions simultaneously.

31. The method of claim 30, wherein the edge detection process uses a tolerance range of expected variances along the Z-plane to assist in the determination of an edge. Deviation along the Z-plane that is outside of the tolerance range will result in an edge and the X-plane and Y-plane positions will be recorded with the Z-plane edge result as an edge position in the surface data.

32. The method of claim 26, wherein the analysis may be accomplished by a human modeler looping out the nail surface data. Where looping involves a visual selection routine of encircling the entire nail surface area and separating that information from any other data included in the original nail surface area datum.

33. The method of claim 25, wherein orienting the nail surface data involves movement along the X, Y and Z planes, with the objective of balancing the Z-plane of the nail surface area along its X- or Y-planes on the sides and positioning the nail surface area where the furthest points of the X- or Y-planes of the front and back edges of the nail surface area are on an equal Z-plane.

34. The method of claim 25, wherein orienting the nail surface data uses the nail surface by creating a front and back of the nail surface area. Where, the front of the nail surface data is the free edge tip of the nail surface and the back of the nail surface data is the cuticle edge of the nail surface.

35. A method of generating a three dimensional artificial nail object involving steps of:
dimensionally referencing a digital natural nail surface area generated from a negative natural nail surface mold, which will become the bottom portion of the desired three dimensional artificial nail object; incorporating preferred parameters and preferences in the creation of the top portion of the desired three dimensional artificial nail object; combining the bottom portion with the top portion, while maintaining the desired thickness parameters, resulting in the overall desired three dimensional artificial nail object.

36. The method of claim 35, wherein referencing the natural nail surface area involves reference to only the nail surface area with no surrounding tissue data.

37. The method of claim 35, wherein referencing the natural nail surface area includes the datum that will become the bottom portion of the desired three dimensional nail object. This datum will represent the result of the impression molding material scan and eventually represents a unique and customized fit in the overall desired three dimensional nail object.

38. The method of claim 35, wherein incorporating preferred parameters and preferences refers to desired parameters which may include shape, style, size, thickness and smile line position.

39. The method of claim 38, wherein shape may include narrowing or widening the overall top portion of the desired three dimensional nail object.

40. The method of claim 38, wherein style may include the determination of designing the tip of the top portion of the desired three dimensional nail object as square, oval or tapered.

41. The method of claim 38, wherein size of the top portion of the desired three dimensional nail object determines how much length of a tip is desired to extend beyond the nail surface datum, generally in reference to the smile line position.

42. The method of claim 38, wherein thickness dictates the overall thickness desired of the three dimensional nail object and this parameter effects the creation of the top portion of the three dimensional object. Thickness may be determined at multiple reference points in relationship to the bottom portion datum, inclusive of any data references along the tip, the cuticle, the free edge and the sides.

43. The method of claim 35, wherein combining the top portion with the bottom portion includes positioning the two portions in relationship to the overall desired thickness parameters to create a desired three dimensional artificial nail object.

44. A method of producing an artificial nail object consisting of:
Taking a three dimensional artificial nail object created with a bottom surface that fits a positive mold of a negative impression mold of a natural nail surface; generating a tool cutting path for a CNC machine; and then cutting the artificial nail object, utilizing the tool cutting path and a CNC, from a chosen material, resulting in the desired artificial nail object.

45. The method of claim 44, wherein the desired three dimensional nail object refers to an object that reflects all desired artistic improvements, while maintaining reference to the customized fitting of the negative impression mold.

46. The method of claim 45, wherein maintaining the reference to the negative impression of the mold may be achieved by creating a positive mold based upon the negative mold and fitting the desired three dimensional nail object onto the positive mold to insure the customized fit.

47. The method of claim 44, wherein generating a tool cutting path for a CNC machine, includes creation of a tool path for a machine to reproduce the artificial nail object.

48. The method of claim 47, wherein the tool path may include tabs attached to the desired three dimensional nail object to insure that the desired nail object maintains its position during the machine cutting process.

49. The method of claim 47, wherein the tool path reflects the top and bottom cut paths involved in the overall creation of the desired artificial nail object.

50. The method of claim 47, wherein the tool path is determined by referencing the chosen material that the artificial nail object is being remove from and evaluating the data of the three dimensional artificial nail object and where intersecting the overall chosen material, recording those points and then evaluating the difference between the chosen material dimensions and the three dimensional artificial nail object and including that information in the tool path.

51. The method of claim 47, wherein the tool path uses instructions for movement of the machine along an X, Y or Z axis, or any combination thereof.

52. The method of claim 44, wherein cutting the artificial nail object involves the determination of the chosen material from which to craft the desired artificial nail.

53. The method of claim 52, wherein the desired media may be composed of metal, plastic, ceramic, or any combination thereof. Where, the plastics may be thermoplastic resins or thermo set types, and; the metal may be any common metal substance which may be heated to a molten state and then molded, and; the ceramics include any type of ceramic material including glass, clay or porcelain.

54. The method of claim 44, wherein cutting the desired artificial nail object involves the use of a CNC machine, the chosen material and the tool cutting path working together to produce the desired artificial nail.

55. The method of claim 54, wherein the CNC machine cuts the three dimensional artificial nail object represented by the tool cutting path out of the chosen material, resulting in the desired artificial nail.
